(19) United States
(12) Patent Application Publication
(10) Pub. No.: US 2002/0056084 A1
(43) Pub. Date: May 9, 2002

(54) Active media content access system

(76) Inventors: Glen McLean Harris, Mississauga (CA); Justin M. Henry, Mississauga (CA)

Correspondence Address: Michael S. Neustel, Suite No. 4, 2534 South University Drive, Fargo, ND, 58103, US

(21) Appl. No.: 09/804,619

(22) Filed: Mar. 12, 2001

Related U.S. Application Data
(60) Provisional application No. 60/189,487, filed on Mar. 15, 2000.

(51) Int. Cl. H04N 7/16

(52) U.S. Cl. 725/1

(57) ABSTRACT

The active media content access system includes a remote control having an electronic system that monitors the date, time, current device, and current channel that a user is currently watching. When the user depresses a selection button during a television event they are interested in receiving more information about, the electronic system immediately logs the event data such as current date, current time, current device and current channel for later uploading to a control station. When the user is finished watching television, they then can connect the electronic system to the Internet and upload the logged event data to the control station which matches the uploaded event data with previously known television programming information received from programming stations to allow for determination of the television event the user was watching when the selection button was depressed. The control station also determines what available information to the send to the user such as e-mail, websites, printed materials, software offers and other information related to the television event the user is interested in receiving additional information about.

### CROSS-REFERENCE TO RELATED U.S. PROVISIONAL PATENT APPLICATIONS

I hereby claim benefit under Title 35, United States Code, Section 119(e) of United States provisional patent application Ser. No. 60/189,487 filed Mar. 15, 2000. This application is a continuation of the No. 60/189,487 application. The No. 60/189,487 application is currently pending. The No. 60/189,487 application is hereby incorporated by reference into this patent application.

### BACKGROUND OF THE INVENTION

1. Field of the Invention

The present invention relates generally to remote control devices and more specifically it relates to an active media content access system for allowing a user to mark one or more television programs for receiving additional information via a global computer network at a later time related to the marked programs.

Television provides an increasing variety of programming to individuals through commercials, infomercials, movies, sitcoms, mini-series and other television broadcasts. Individuals watching a television broadcast often times desire to receive additional information and/or promotional materials relating to a specific broadcast they are watching.

One valuable resource for receiving additional information regarding information viewed during a television program is through global computer networks (e.g. Internet). However, since the individual is typically interested in the programming specifically tuned to and the computer connected to the Internet is often times in another room, the individual often times never researches the information they are interested in after the programming is finished for various reasons.

One solution to this problem is to “merge” the television with the home computer thereby allowing consumers to access information directly through their television after viewing a particular television item. However, many households currently have not purchased the technology required for television-Internet access and are unable to effectively utilize the power of the Internet in combination with their television.

Hence, there is a need for a remote control system that allows a consumer to selectively “mark” an item of programming they are interested in receiving additional information about via the Internet that is easy and simple to utilize.

2. Description of the Prior Art

Television programming has been a valuable advertising and promotional tool for businesses and other entities since the creation of the television. Television provides an effective medium for businesses and groups to convey their message to consumers. Typical television programming consists of commercials, infomercials, documentaries, biographies, movies, sitcoms, mini-series and other items.

The main problem with conventional television programming is that it does not allow for an individual to receive additional information regarding a particular television item that the individual is currently watching. Another problem with conventional television programming is that television advertisers lose valuable customers because of the delay of time after an advertisement until the consumer is able to access a computer or telephone resulting in the consumer forgetting about the commercial or losing interest in the subject matter. A further problem with conventional television programming is that there is no effective means for directing desired information to television watchers that are very interested in a particular television program.

Conventional remote control units are typically comprised of a housing structure with a plurality of buttons within a keypad. Conventional remote control units are typically capable of mainly controlling the operation of the television and possibly other external electronic devices. The main problem with conventional remote control units is that they are unable to provide the user with the ability to select (i.e. mark) television programming that they are interested in receiving additional information about later via the Internet.

While these devices may be suitable for the particular purpose to which they address, they are not as suitable for allowing a user to mark one or more television programs for receiving additional information via a global computer network at a later time related to the marked programs. Conventional television programming simply does not allow for consumers to effectively receive additional information regarding television programming.

In these respects, the active media content access system according to the present invention substantially departs from the conventional concepts and designs of the prior art, and in so doing provides an apparatus primarily developed for the purpose of allowing a user to mark one or more television programs for receiving additional information via a global computer network at a later time related to the marked programs.

### SUMMARY OF THE INVENTION

In view of the foregoing disadvantages inherent in the known types of remote control devices and television programming now present in the prior art, the present invention provides a new active media content access system construction wherein the same can be utilized for allowing a user to mark one or more television programs for receiving additional information via a global computer network at a later time related to the marked programs.

The general purpose of the present invention, which will be described subsequently in greater detail, is to provide a new active media content access system that has many of the advantages of the remote control devices mentioned heretofore and many novel features that result in a new active media content access system which is not anticipated, rendered obvious, suggested, or even implied by any of the prior art remote control devices, either alone or in any combination thereof.

To attain this, the present invention generally comprises a remote control having an electronic system that monitors the date, time, media type (e.g. cable vs. satellite vs. antenna) and current channel that a user is currently viewing. When the user depresses a selection button during a television program they are interested in receiving more information about, the electronic system immediately logs the date, time, media type and current channel for later uploading to a control station. During and after watching television, the user may then connect the electronic system to the Internet and upload the logged information to the control station which matches the logged information with previously known programming information to allow for determination of the programming the user was watching when the selection button was depressed. The control station determines what available information to the send to the user such as email, websites, printed materials, software offers and other information related to the programming the user is interested in.

There has thus been outlined, rather broadly, the more important features of the invention in order that the detailed description thereof may be better understood, and in order that the present contribution to the art may be better appreciated. There are additional features of the invention that will be described hereinafter and that will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

A primary object of the present invention is to provide an active media content access system that will overcome the shortcomings of the prior art devices.

A second object is to provide an active media content access system for allowing a user to mark one or more television programs for receiving additional information via a global computer network at a later time related to the marked programs.

Another object is to provide an active media content access system that provides an effective method for advertisers to communicate with consumers interested in their products and services.

An additional object is to provide an active media content access system that provides an effective method for television stations to communicate with consumers interested in their television programming regarding specific programming.

A further object is to provide an active media content access system that allows businesses to forward additional information to consumers via e-mail, web sites, and mailings regarding subject matter a consumer has specifically shown interest in.

Another object is to provide an active media content access system that allows businesses to efficiently market their products and services to a group of consumers showing an interest in their products or services without wasting valuable resources promoting items to non-interested consumers.

A further object is to provide an active media content access system that does not require any changes to existing broadcast infrastructure thereby requiring no changes to the media content for operation thereof.

Another object is to provide an active media content access system that will work with existing electronic device within a room without changes to the devices.

Other objects and advantages of the present invention will become obvious to the reader and it is intended that these objects and advantages are within the scope of the present invention.

To the accomplishment of the above and related objects, this invention may be embodied in the form illustrated in the accompanying drawings, attention being called to the fact, however, that the drawings are illustrative only, and that changes may be made in the specific construction illustrated and described within the scope of the appended claims.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 is an upper perspective view of the present invention.

FIG. 2 is a side view of the present invention.

FIG. 3 is a side view of the present invention illustrating electronic circuitry within.

FIG. 4 is a block diagram illustrating the communications between the present invention and a plurality of external electronic devices.

FIG. 5 is a block diagram illustrating the electronic system of the present invention electrically connected to the power source and in communication with the external electronic devices.

FIG. 6 is a block diagram illustrating the electronic system along with a plurality of accessory devices connected to thereof.

FIG. 7 is a block diagram of the present invention in communication with the control station via a global computer network wherein the electronic system is directly connected to an intermediary computer system.

FIG. 8 is a block diagram of the present invention in communication with the control station directly via a global computer network without utilizing an intermediary computer system.

FIG. 9 is a flowchart illustrating the operation of the remote control and the selection button during the watching of television programming by the user.

FIG. 10 is a flowchart illustrating the uploading of logged data contained within the remote control.

FIG. 11 is a flowchart illustrating the receiving and utilization of log data from the remote control to determine whether or not to send information to the user.

FIG. 12 is a flowchart illustrating the determination of the information desired by the user and the form of its availability.

### DESCRIPTION OF THE PREFERRED EMBODIMENT

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not intended to be limited to the embodiments shown, but is to be accorded the widest scope consistent with the principles and features disclosed herein.

The data structures and code described in this detailed description are typically stored on a computer readable storage medium, which may be any device or medium that can store code and/or data for use by a computer system. This includes, but is not limited to, magnetic and optical storage devices such as disk drives, magnetic tape, CDs (compact discs) and DVDs (digital video discs), and computer instruction signals embodied in a transmission medium (with or without a carrier wave upon which the signals are modulated). For example, the transmission medium may include a communications network, such as but not limited to the Internet or wireless communications.

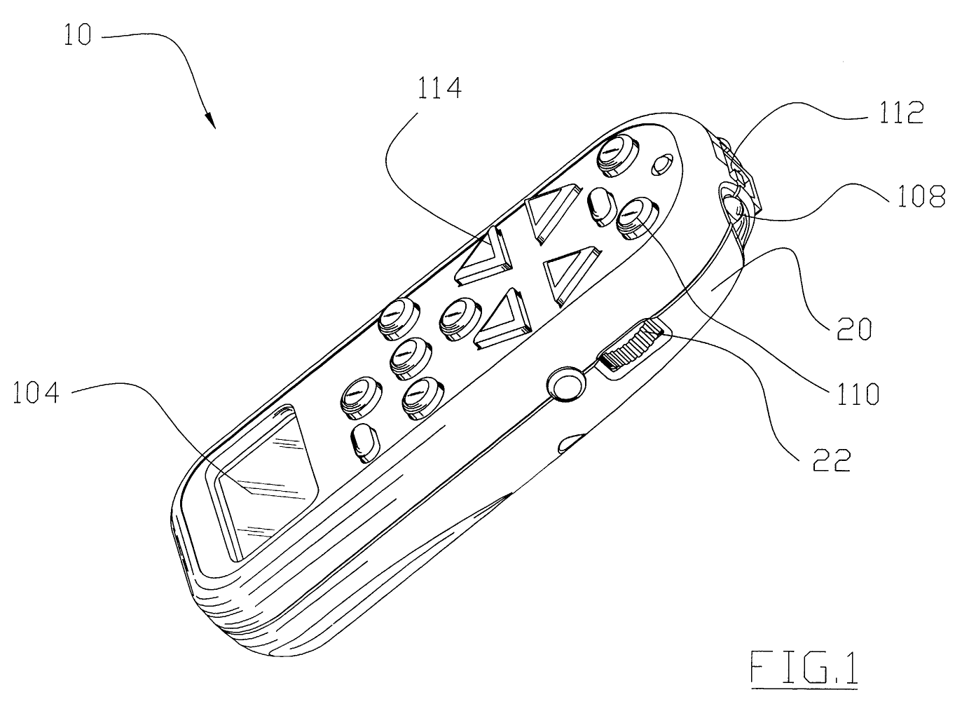

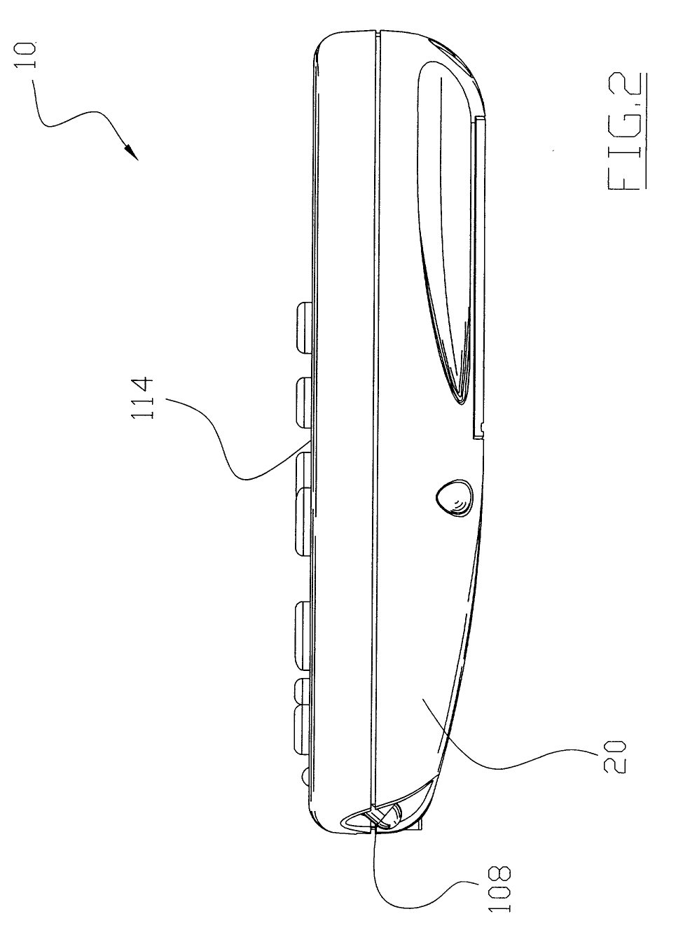

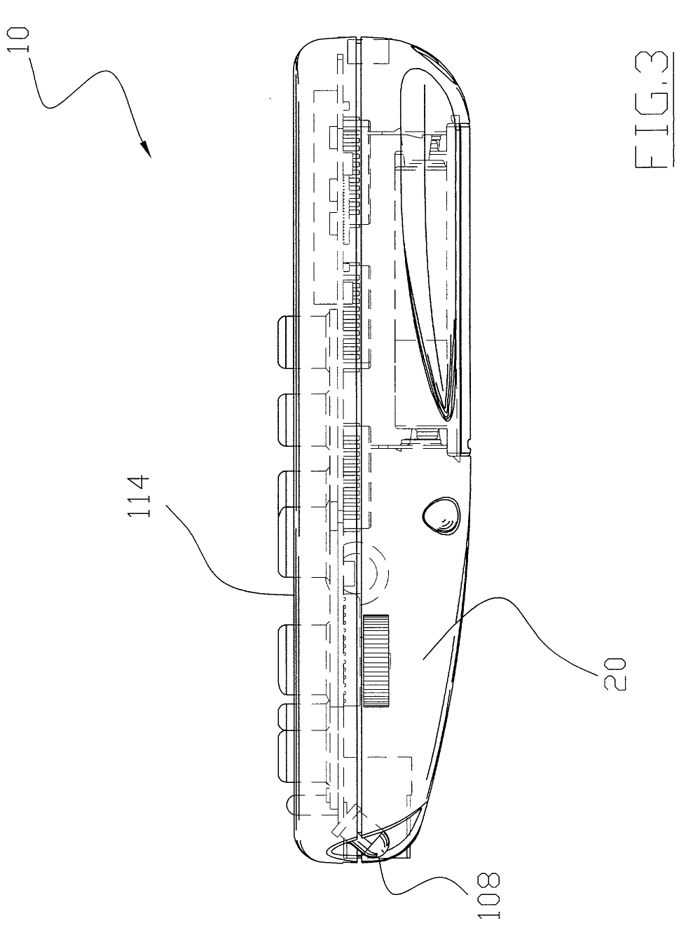

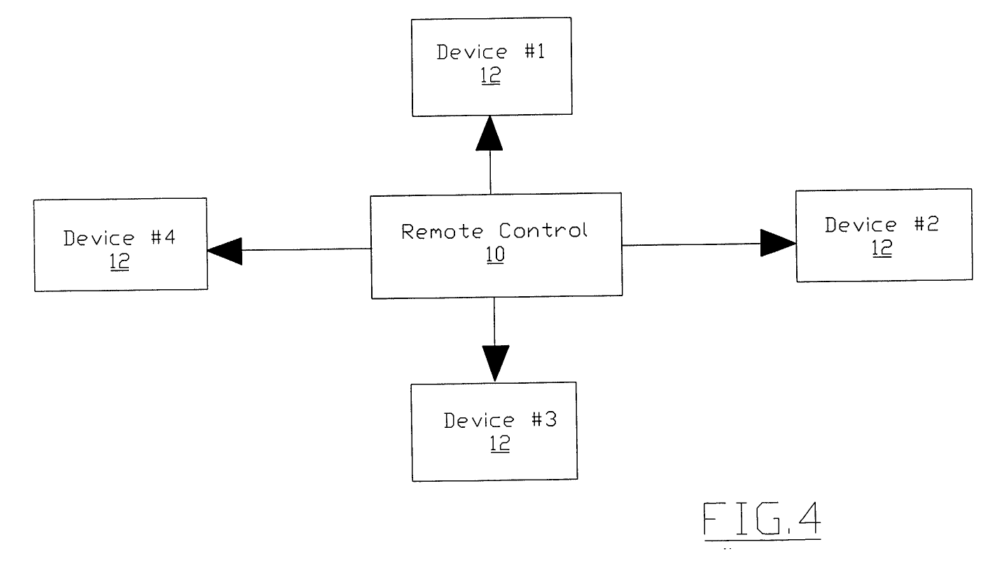

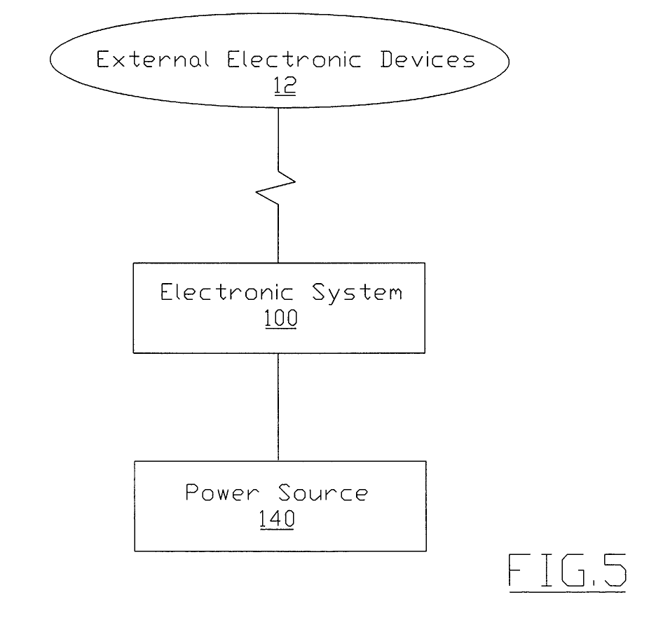

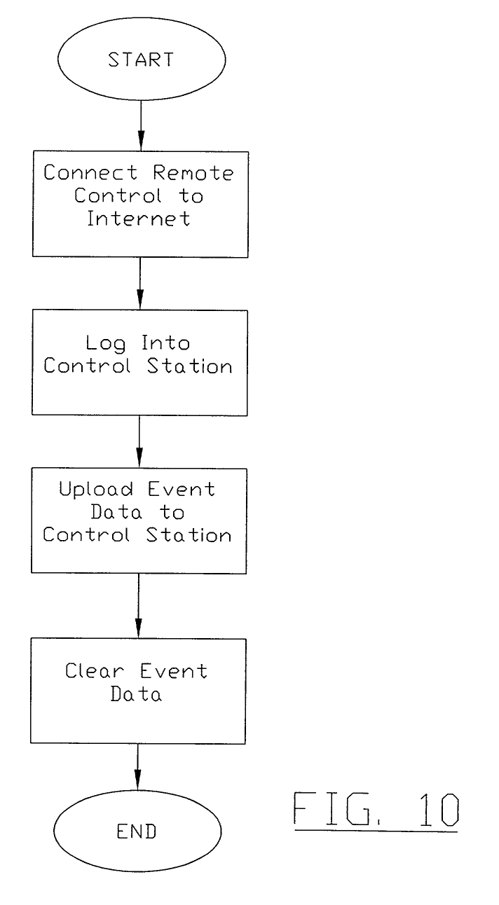

Turning now descriptively to the drawings, in which similar reference characters denote similar elements throughout the several views, FIGS. 1 through 12 illustrate an active media content access system 10, which comprises a remote control having an electronic system 100 that monitors the date, time, media type, and current channel that a user is currently watching. When the user depresses a selection button 110 during a television program they are interested in receiving additional information about, the electronic system 110 immediately logs the date, time, media type, and current channel for later uploading to a control station 40. When the user is finished watching television, they then connect the electronic system 100 to the Internet 130 and upload the logged information to the control station 40 which matches the logged information with previously known programming information to allow for determination of the programming the user was watching when the selection button 110 was depressed. The control station 40 determines what available information to the send to the user such as e-mail, websites, printed materials, software offers and other information related to the programming the user is interested in.

A. Remote Control Structure

The present invention generally is comprised of a housing 20 having a structure and shape similar to conventional remote control devices. The housing 20 may be constructed of various types of materials and shapes as can be appreciated by one skilled in the art. The housing is preferably structured to be ergonomic for a majority of users.

The present invention may be utilized to control and operate various external electronic devices including but not limited to televisions, stereos, receivers, VCRs, DVD players, CD players, amplifiers, equalizers, tape players, cable units, satellite dish receivers, lighting, window shades and other electronic devices. Almost any number of external electronic devices may be controlled by the present invention as can be accomplished with conventional remote control devices.

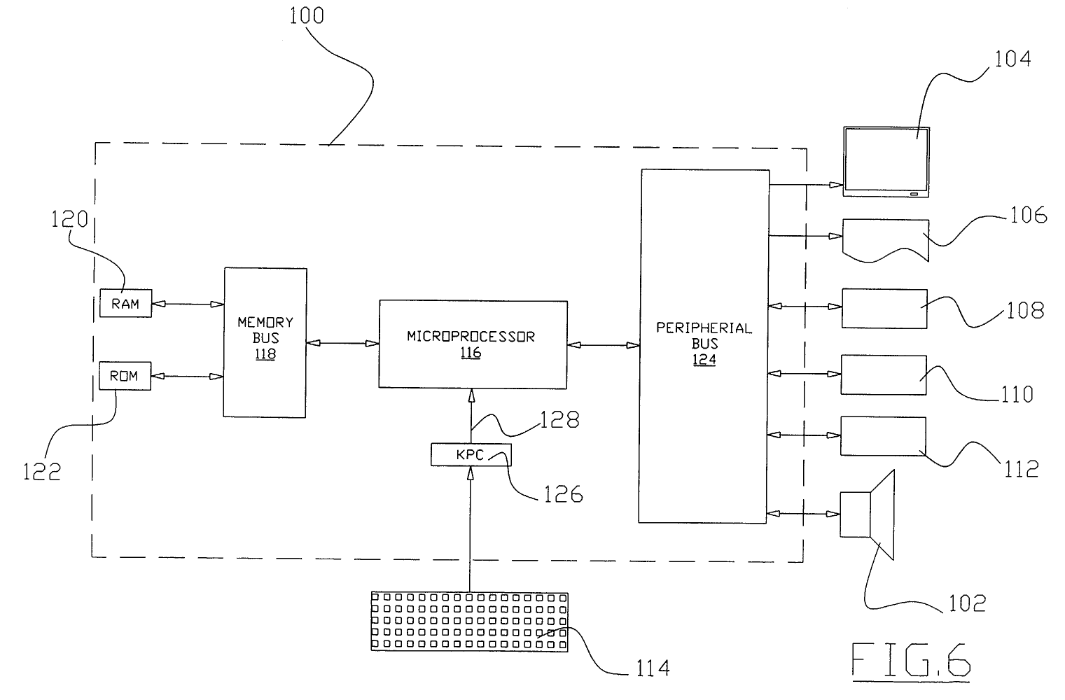

FIG. 6 is a block diagram of an exemplary electronic system 100 for practicing the various aspects of the present invention. The electronic system 100 is preferably enclosed within the housing. A portable power source 140 is electrically connected to the electronic system 100 for providing electrical power to the electronic system 100. The power source 140 may be comprised of any power source such as a battery structure (disposable or rechargeable), solar cells, or direct power.

The electronic system 100 preferably includes a display screen 104, a network interface 112, a keypad 114, a microprocessor 116, a memory bus 118, random access memory (RAM) 120, a speaker 102, read only memory (ROM) 122, a peripheral bus 124, a keypad controller 126, and a communications device 108. As can be appreciated, the electronic system 100 of the present invention may be comprised of any combination of well-known computer devices, personal digital assistants (PDAs), laptop computers, remote control devices and other electronic systems.

The microprocessor 116 is a general-purpose digital processor that controls the operation of the electronic system 100. Microprocessor 116 can be a single-chip processor or implemented with multiple components. Using instructions retrieved from memory, microprocessor 116 controls the reception and manipulations of input data and the output and display of data on output devices.

The memory bus 118 is utilized by microprocessor 116 to access RAM 120 and ROM 122. RAM 120 is used by microprocessor 116 as a general storage area and as scratch-pad memory, and can also be used to store input data and processed data. ROM 122 can be used to store instructions or program code followed by microprocessor 116 as well as other data.

Peripheral bus 124 is used to access the input, output and storage devices used by the electronic system 100. In the described embodiment(s), these devices include a display screen 104, an accessory device 106, a speaker 102, a communications device 108, and a network interface 112. A keypad controller 126 is used to receive input from the keypad 114 and send decoded symbols for each pressed key to microprocessor 116 over bus 128.

The display screen 104 is an output device that displays images of data provided by the microprocessor 116 via the peripheral bus 124 or provided by other components in the electronic system 100. Other output devices such as a printer, plotter, typesetter, etc. can be utilized as an accessory device 106.

The microprocessor 116 together with an operating system operate to execute computer code and produce and use data. The computer code and data may reside on RAM 120, ROM 122, or other storage mediums. The computer code and data could also reside on a removable program medium and loaded or installed onto the electronic system 100 when needed. Removable program mediums include, for example, PCCARD, flash memory, and floppy disk.

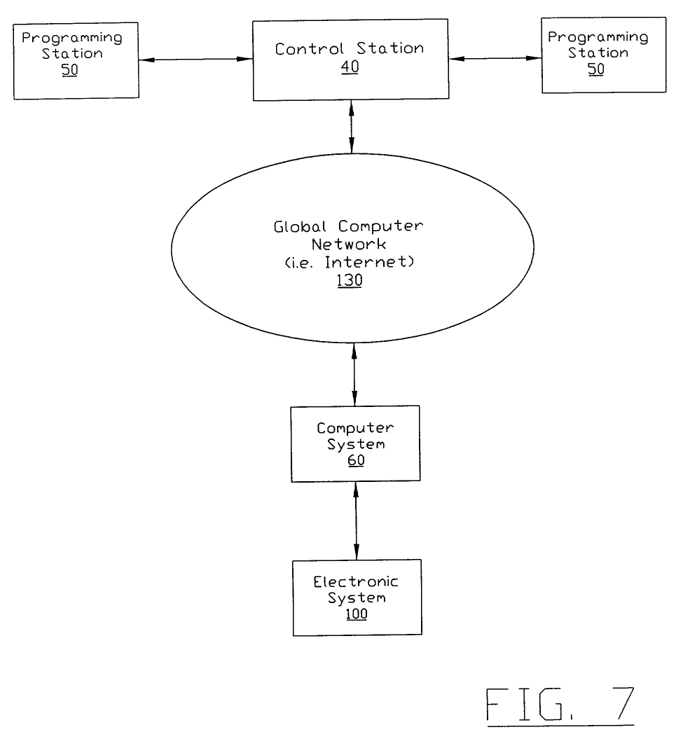

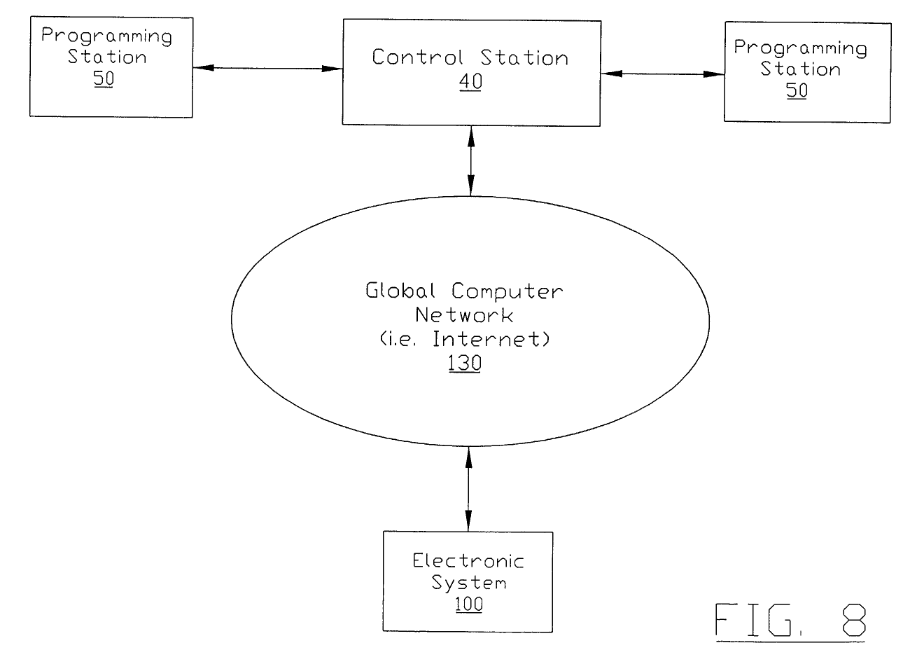

The network interface 112 is utilized to send and receive data over a network connected to other electronic systems. The network interface may also be comprised of a Universal Serial Bus (USB), an external bus standard that supports data transfer rates of 12 Mbps (12 million bits per second). A single USB port can be used to connect up to 127 peripheral devices, such as mice, modems, and keyboards. An interface card or similar device and appropriate software implemented by microprocessor 116 can be utilized to connect the electronic system 100 to an existing network and transfer data according to standard protocols including data over a global computer network such as the Internet. The electronic system 100 may connect to the Internet 130 via a computer system 60 or directly as illustrated in FIGS. 7 and 8 respectively.

The keypad 114 is used by a user to input commands and other instructions to the electronic system 100. Other types of user input devices can also be used in conjunction with the present invention. For example, pointing devices such as a computer mouse, a jog switch 22, a track ball, a stylus, or a tablet to manipulate a pointer on a screen of the electronic system 100.

The present invention can also be embodied as computer readable code on a computer readable medium. The computer readable medium is any data storage device that can store data which can be thereafter be read by a electronic system. Examples of the computer readable medium include read-only memory, random-access memory, magnetic data storage devices such as diskettes, and optical data storage devices such as CD-ROMs. The computer readable medium can also be distributed over a network coupled electronic systems so that the computer readable code is stored and executed in a distributed fashion.

The communications device 108 may be comprised of any well-known communication system that allows communications with external electronic devices. The communications device 108 may provide for various types of communication such as but not limited to via infrared (IR), wireless (e.g. BLUETOOTH), unidirectional, bi-directional, radio frequency (RF), visible light, ultrasonic and various other means for communicating with external electronic devices.

Input into the electronic system is accomplished mainly through the usage of the keypad 114. The keypad 114 includes a plurality of buttons that allow the user to execute one or more commands. The keypad 114 allows for the control of basic functions such as volume, channel manipulation, mute, and last channel. Various other input devices may be utilized to input data into the electronic system 100 such as a jog switch 22 (i.e. dial), motion and orientation detectors, touch sensitive screens and voice recognition. The display 104 provides information to the user such as possible tasks to complete or the current state of the external electronic devices.

The electronic system must be capable of storing and logging various types of “event data” such as date, time, current channel and other types of information relevant to determining the identity of a specific television program at a particular time. The remote control may be comprised of various other well-known structures and functions known in the art. It can also be appreciated that the present invention as disclosed does not require the functionality to control a television or other electronic devices.

B. Communication System

The present invention is best operated upon a global computer network such as the Internet 130. A plurality of computer systems around the world are in communication with one another via this global computer network.

The present invention preferably utilizes the Internet 130 for communications, however it can be appreciated that as future technologies are created that various aspects of the invention may be practiced with these improved technologies. In addition, wireless technologies provide a suitable communications medium for operating the present invention.

C. Web Page

The present invention is preferably utilized in conjunction with information presented upon a web page or other displayable medium representing the control station 40. A web page is typically comprised of a web page code that is stored upon a computer server. A typical web page includes textual, graphical and audio data within for display upon a computer system 60 and may be comprised of various formats.

The web page code may be formatted such as but not limited to HTML (HyperText Markup Language), XML (Extensible Markup Language), HDML (Handheld Device Markup Language), and WML (Wireless Markup Language) that is displayable upon a computer system. Scripts such as JavaScript may be included within the web page code to request the server computer to request a specific audio file to be played with respect to an advertisement. As can be appreciated, additional formats for the web page code may be utilized as developed.

The web page code is retrieved by a computer system 60 or electronic system 100 via the Internet, wireless network or other communications channel utilizing a conventional web browser such as but not limited to NETSCAPE or MICROSOFT INTERNET EXPLORER. An individual using the consumer computer system 60 enters the URL (Uniform Resource Locator) or the electronic system 100 enters the URL identifying the web page to retrieve the web page code associated with the desired web page.

D. Selection Button

The selection button 110 is preferably positioned within a convenient location upon the keypad 114 and in communication with the electronic system 100 so the user can easily depress the selection button 110 when a television event is displayed that the user is interested in receiving additional information about. The selection button 110 is preferably positioned in an easy to access location upon the remote control as shown in FIGS. 1 through 3 of the drawings.

Upon depressing of the selection button 110, the electronic system 100 “logs” the “event data” (e.g. date, time, media type, and current channel). It can be appreciated that the user may have the option of inputting additional data to correspond with the event data such as limiting the type of information they desire to receive relating to the television event.

E. Event Data

“Event data” such as date, time, current channel, settings and other types of information is utilized by the control station 40 to identity the specific television program at a particular time. Event data may also include additional information such as the user's preferences regarding the information they receive. For example, the user could program into the electronic system 100 that they desire to only receive e-mail and web site information regarding television events they are interested in. Various other types of information may be input by the user and recorded by the electronic system 100 that are relevant to television event information and user preferences.

F. Control Station

The control station 40 is in communication with the Internet 130 via various well-known means. The control station 40 is preferably accessed by users via a web page which allows the users to identify themselves and modify user settings. The user may input various conditions and requirements regarding the additional information they receive via this web page which may also be accomplished by inputting additional data into the electronic system 100.

The user may control via the control station 40 the amount of information they receive (e.g. no more than 5 e-mails per day), the type of information they receive (e.g. only e-mails), when and where they receive the information (e.g. after 5 p.m. only for e-mails directed to their home e-mail address) and other control settings that are desirable by a user. The user control settings may be modified at any time via the web page or other means.

The control station 40 is in communication with one or more programming stations 50 that provide updated television event information to the control station 40. The programming stations 50 may be comprised of broadcasters, advertisers or other entities able to provide the necessary programming information. The television event information is basically comprised of date, time, channel, settings, title and other related information. It can be appreciated that additional types of event information may be received and stored by the control station 40.

In addition to the television event information, the control station 40 maintains “available information” data relating to each of the television events. The available information data is basically comprised of a listing of information available to provide to the user if they are interested in receiving additional information about a specific television event. The television event information and the available information may be maintained in a single or separate databases as can be appreciated. In addition, the television event information and the available information are periodically updated to ensure the accuracy of the information in case of changes in television programming and available information.

G. Information Provided to User

It can be appreciated that a virtually unlimited amount of information may be provided to a user regarding various programming events that they mark with the selection button 110. Information such as e-mails, web site information, printed materials, and sample products may be provided to the user relating to the programming they are interested in.

Additional information may be provided to the user such as product samples, product offers and discounts, software, promotional items, screensavers, and the like. The information provided to the user may be sent immediately after the control station 40 determines the television event the user is interested in or over a period of time wherein the user is basically maintained on a “mailing list” to receive additional information in the future.

H. Operation

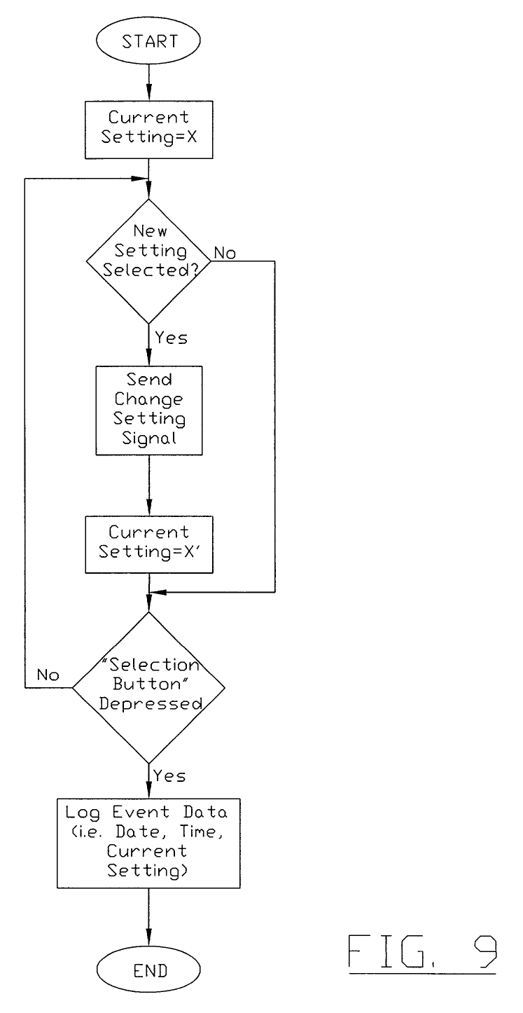

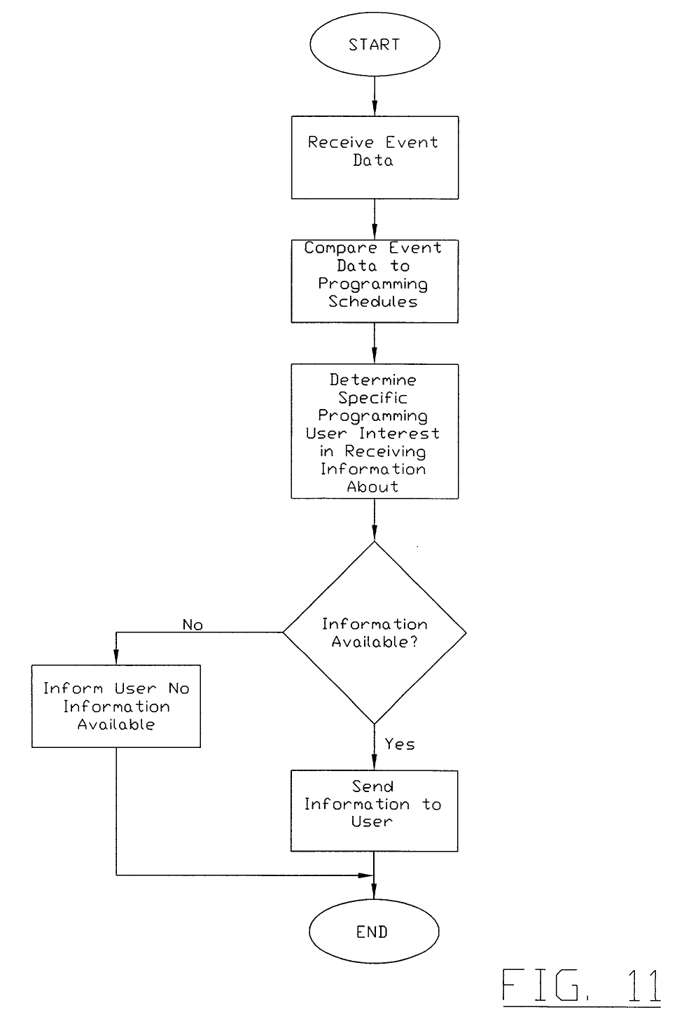

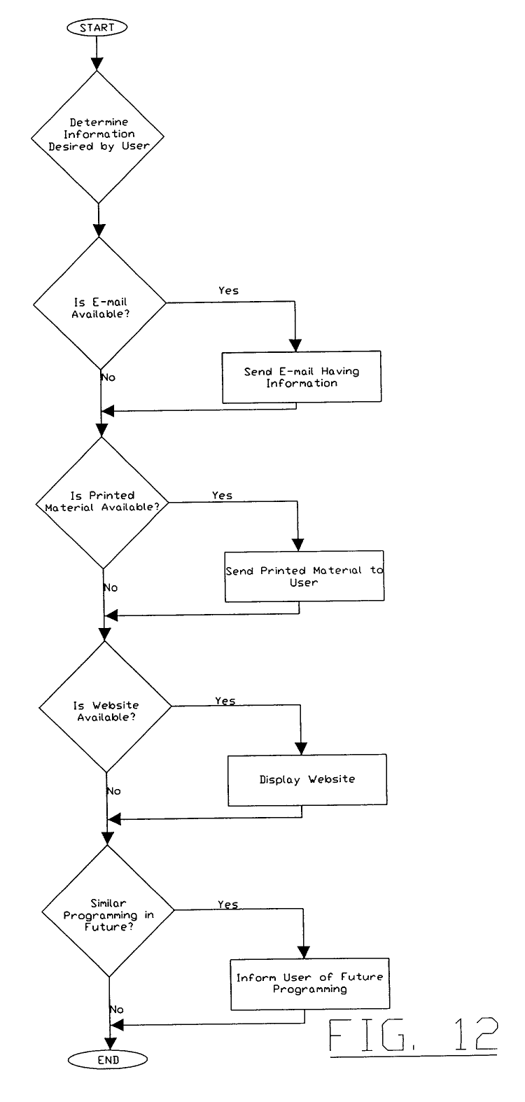

In use, the user first ensures that the electronic system 100 has the correct date and time information. If the date and/or time are incorrect, the user reprograms the electronic system 100 via the keypad 114 to contain the correct date and time or the date/time may be automatically updated when connected to the control station 40. The user would also input the current channel the television or other device is set to allow for synchronization of the electronic system 100 with the television or other device. The user then utilizes the remote control to switch the current channel either by directly entering the channel number or by selecting a “channel up” or “channel down” button that are common with conventional remote controls for controlling a television, cable box, television, VCR, or other electronic device controlling the media the user is viewing and listening to. The electronic system 100 constantly monitors the “current channel” by compensating for selections of the channel up or channel down buttons on the keypad 114 to allow for “mirroring” the settings (e.g. power on/off, channel, volume level, video/audio input, etc.) of the television or other channel control device as is illustrated in FIG. 9 of the drawings. When the user is viewing a television event they are interested in receiving additional information about (e.g. commercial, television program, infomercial, etc.), they depress the selection button 110 wherein the electronic system 100 logs the event data (e.g. date, time and current channel) along with any additional information such as user preferences as is further shown in FIG. 9 of the drawings. The user continues watching television and may select addition television events wherein the event data is logged by the electronic system 100. After the user is finished watching television, they may then upload the logged event data to the control station 40 as shown in FIGS. 7, 8, 10 and 11 of the drawings. The uploading of the logged event data may be in real-time and continuous. After uploading the event date, the event data is preferably cleared from the electronic system 100 to prevent duplication of information sent to the user. When the control station 40 receives the uploaded event data, the control station 40 compares the event data to the programming schedules received from the programming stations 50 to determine the actual television event the user is interested in receiving additional information about. If no information is available, the user is informed that “No Information is Available” for the specific television event. If information is available to send to the user, then depending upon the type of information available and the preferences preset by the user, various types of information may be sent to the user relating to the television event(s) they are interested in as is shown in FIGS. 11 and 12 of the drawings.

As to a further discussion of the manner of usage and operation of the present invention, the same should be apparent from the above description. Accordingly, no further discussion relating to the manner of usage and operation will be provided.

With respect to the above description then, it is to be realized that the optimum dimensional relationships for the parts of the invention, to include variations in size, materials, shape, form, function and manner of operation, assembly and use, are deemed to be within the expertise of those skilled in the art, and all equivalent structural variations and relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

We claim:

1. An active media content access system, comprising:
a control station;
a housing;
an electronic system capable of storing and uploading event data relating to at least one television event, wherein said electronic system contains a current time, current date, current device and current channel;
a communication device connected to said electronic system for uploading said event data to said control station; and
an input means connected to said electronic system for indicating when said electronic system should log event data comprised of said current time, said current date and said current channel.

2. The active media content access system of claim 1, wherein said input means includes a selection button.

3. The active media content access system of claim 2, wherein said input means includes a display and a keypad.

4. The active media content access system of claim 3, wherein said electronic system is capable of receiving user preference data relating to personal preferences.

5. The active media content access system of claim 4, wherein said control station is in communication with a plurality of programming stations for receiving updated television event information.

6. The active media content access system of claim 5, wherein said control station compares said event data to said television event information to determine what type of information to send to said user.

7. The active media content access system of claim 6, wherein said control station is programmable by said user to reflect said personal preferences.

8. The active media content access system of claim 7, wherein said personal preferences includes type of information to receive relating to said television event.

9. The active media content access system of claim 8, wherein said communication device is in communication with said control station via a global computer network.

10. A method of using an active media content access system having an electronic system with a communication device and an input device, wherein said communication device is in communication with a control station, said method comprising the steps of:
(a) viewing a television event;
(b) receiving a log event data indication from a user; and
(c) logging an event data within said electronic system, wherein said event data is comprised of a current date, a current time, a current device and a current channel at the time of receiving said log event data indication.

11. The method of using an active media content access system of claim 10, including the step of:
(d) uploading said event data to said control station.

12. The method of using an active media content access system of claim 11, including the steps of:
(e) determining an identity of said television event from said event data; and
(f) determining whether information is available regarding said television event.

13. The method of using an active media content access system of claim 12, including the step of:
(g) providing available information to said user.

14. The method of using an active media content access system of claim 13, including the step of:
(h) sending an e-mail containing said available information to said user.

15. The method of using an active media content access system of claim 12, including the step of:
(g) providing available information depending upon predefined user preferences.

16. A method of using an active media content access system having an electronic system with a communication device and an input device, wherein said communication device is in communication with a control station, said method comprising the steps of:
(a) initializing a current date, a current time, a current device and a current channel into said electronic system;
(b) viewing a television event;
(c) receiving a log event data indication from a user; and
(d) logging an event data within said electronic system, wherein said event data is comprised of a current date, a current time, a current device and a current channel at the time of receiving said log event data indication.

17. The method of using an active media content access system of claim 16, including the step of:
(e) uploading said event data to said control station.

18. The method of using an active media content access system of claim 17, including the steps of:
(f) determining an identity of said television event from said event data; and
(g) determining whether information is available regarding said television event.

19. The method of using an active media content access system of claim 18, including the step of:
(h) providing available information to said user.

20. The method of using an active media content access system of claim 19, including the step of:
(i) sending an e-mail containing said available information to said user.
